(19) United States
(12) Patent Application Publication
(10) Pub. No.: US 2019/0073674 A1
(43) Pub. Date: Mar. 7, 2019

(54) SYSTEMS AND METHODS FOR ITEM-BASED TRANSACTION AUTHENTICATION

(71) Applicant: CAPITAL ONE SERVICES, LLC, McLean, VA (US)

(72) Inventors: Matthew B. Stern, San Francisco, CA (US); Makiko Taniguchi, San Francisco, CA (US); Daniel Makoski, Palo Alto, CA (US); Lin Yang, San Francisco, CA (US); Carl A. Cepress, Santa Clara, CA (US); Austin Anderson, San Francisco, CA (US); Jason DePerro, Burlingame, CA (US)

(73) Assignee: CAPITAL ONE SERVICES, LLC, McLean, VA (US)

(21) Appl. No.: 16/178,533

(22) Filed: Nov. 1, 2018

Related U.S. Application Data
(62) Division of application No. 15/226,883, filed on Aug. 2, 2016.
(60) Provisional application No. 62/200,359, filed on Aug. 3, 2015.

(51) Int. Cl. G06Q 20/40; G06Q 20/32

(52) U.S. Cl. CPC G06Q 20/409; G06Q 20/3276; G06Q 20/322; G06Q 20/40

(57) ABSTRACT

Disclosed embodiments include methods, systems, and computer-readable media configured to, for example, authenticate a transaction using an item at a mobile device. An example method comprises receiving an indication to start an application on the mobile device, displaying a user interface, by the application, a request for a capture of a pattern on an item, receiving, by the application, a pattern capture from the item, determining whether the pattern capture is complete, and sending the pattern capture to a first remote system for authenticating a transaction. Disclosed embodiments also include a card comprising visible first information about an account associated with the card, a machine-readable item comprising second information (which may have information in common with the first information), and a pattern comprising at least one marking including at least one of invisible ink or capacitive ink, that does not include the first information or the second information.

### RELATED APPLICATIONS

This application claims priority to U.S. Patent Application Publication No. 62/200,359, filed Aug. 3, 2015, the disclosure of which is hereby incorporated by reference in its entirety.

### BACKGROUND

Many types of interactions on computer systems, such as authenticated log-ins and other transaction-based processes, are insecure. For example, when attempting to log in to a website on a computer, the website may request a username and password. Anyone with that set of information—be it an authorized user or a nefarious one—may use the website for any purpose.

To combat this insecurity, some transactions require multi-factor authentication—often referred to as “what you know and what you have.” For example, when logging into a website, the website may request a username/password combination (“what you know”) along with a 6-digit number displayed on an electronic device (“what you have”). The 6-digit number may change every 30 seconds so as to avoid reuse by an unauthorized user. But this system suffers from its own disadvantages, technological and otherwise. For example, if the electronic device runs out of power (e.g., the battery dies) the user will be unable to authenticate and will be unable to perform a transaction.

As another example, a credit card may have information stored on it that can enable a credit card processor to know whether the card is physically present in the user's hands. For example, while the card may have a card number printed on the obverse (“what you know”) some information may only be present as part of a magnetic stripe on its reverse (“what you have”). But this also lacks the ideal level of security in that a nefarious user may be able to simply copy the magnetic stripe and print it on a new card.

There is thus a need to address these and other problems The present disclosure provides devices, methods, systems, and computer-readable media to solve these and other issues.

### SUMMARY

Disclosed embodiments include methods, systems, and computer-readable media configured to, for example, authenticate a transaction using an item at a mobile device. An example method comprises receiving an indication to start an application on the mobile device, and displaying a user interface, by the application, a request for a capture of a pattern on an item. The method further comprises receiving, by the application, a pattern capture from the item, determining whether the pattern capture is complete, and sending the pattern capture to a first remote system for authenticating a transaction.

Systems and computer-readable media implementing the above method are also provided.

Disclosed embodiments also include a card. The card comprises visible first information about an account associated with the card. The card also comprises a machine-readable item comprising second information. The second information may comprise information in common with the first information. The card may also comprise a pattern comprising at least one marking including at least one of invisible ink or capacitive ink. The pattern, in some embodiments, does not include the first information or the second information.

Aspects of the disclosed embodiments may include tangible computer-readable media that stores software instructions that, when executed by one or more processors, are configured to and capable of performing and executing one or more of the methods, operations, and the like consistent with the disclosed embodiments. Also, aspects of the disclosed embodiments may be performed by one or more processors configured as special-purpose processor(s) based on software instructions that are programmed with logic and instructions that perform, when executed, one or more operations consistent with the disclosed embodiments. Moreover, aspects of the disclosed embodiments may be implemented on specialized (rather than generic) equipment or devices.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2A is a diagram of an exemplary card, consistent with disclosed embodiments.

FIG. 2B is a diagram of an exemplary card, consistent with disclosed embodiments.

FIG. 2C is a diagram of an exemplary card, consistent with disclosed embodiments.

FIG. 3A is a flowchart of an exemplary process for initiating a transaction using an authentication system and a mobile device, consistent with disclosed embodiments.

FIG. 3B is a flowchart of an exemplary process for authenticating a transaction using a touchscreen display, consistent with disclosed embodiments.

FIG. 3C is a flowchart of an exemplary process for authenticating a transaction using a camera on a mobile device, consistent with disclosed embodiments.

FIG. 4A is a diagram of an exemplary user interface for a mobile device, enabling authentication of a transaction using an item having contact points, consistent with disclosed embodiments.

FIG. 4B is a diagram of an exemplary user interface for a mobile device, enabling authentication of a transaction using a card having an ink pattern, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts. Embodiments of the present disclosure relate to a mobile device detecting tags affixed to or associated with items and maintaining a list of those detected items on the mobile device or another device. In some embodiments, the list may be a shopping cart or checkout list.

Embodiments of the present disclosure are directed to authenticating transactions or other processes using items having one or more of invisible ink (e.g., emitting ultraviolet light alone) or conductive contact points. While some embodiments envision using a card as this item, other items—such as figurines, tokens, key fobs, or the like—can be used as well.

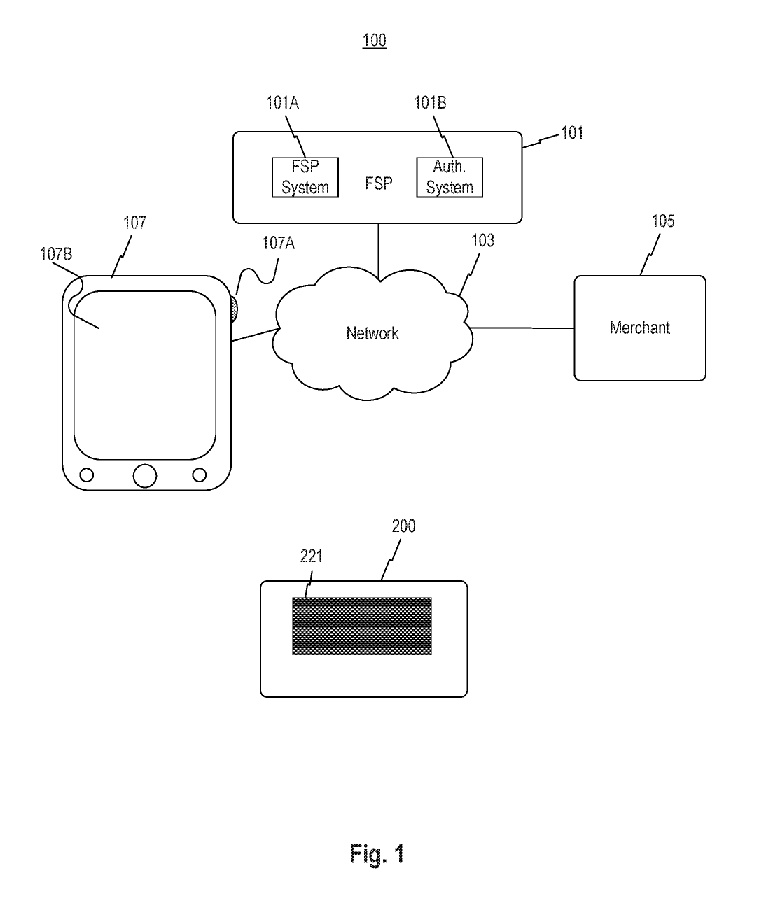

FIG. 1 is a block diagram of an exemplary system 100 for performing one or more operations consistent with the disclosed embodiments. In one embodiment, system 100 may include one or more of the following: financial services provider (FSP) 101, a network 103, a merchant device 105, a mobile device 107. The devices in system 100, moreover, may send data to, read data from, or otherwise have communication with item 200. The components and arrangement of the components included in system 100 may vary. Thus, system 100 may include other components that perform or assist in the performance of one or more processes consistent with the disclosed embodiments.

Components of system 100 may be computing systems configured to provide systems and method for pre-authorizing a transaction request, consistent with disclosed embodiments. As further described herein, components of system 100 may include one or more computing devices (e.g., computer(s), server(s), etc.), memory storing data and/or software instructions (e.g., database(s), memory devices, etc.), and other known computing components. In some embodiments, the one or more computing devices may be configured to execute software instructions stored on one or more memory devices to perform one or more operations consistent with the disclosed embodiments. Components of system 100 may be configured to communicate with one or more other components of system 100, including systems associated with FSP 101, network 103, merchant device 105, and mobile device 107. In certain aspects, users may operate one or more components of system 100 to initiate and provide input for one or more operations consistent with the disclosed embodiments.

Financial service provider 101 may be an entity that provides, maintains, manages, or otherwise offers financial services. For example, FSP 101 may be a bank, credit union, credit card issuer, gift card processor, or any other type of financial service entity that generates, provides, manages, and/or maintains financial service accounts for one or more users. Financial service accounts may include, for example, credit card accounts, loan accounts, checking accounts, savings accounts, reward or loyalty program accounts, and/or any other type of financial service account known to those skilled in the art. FSP 101 may include infrastructure and components that are configured to generate and/or provide financial service accounts such as credit card accounts, checking accounts, debit card accounts, loyalty or reward programs, lines of credit, stored-value accounts, or the like. Consistent with certain disclosed embodiments, financial service provider 101 may provide manufacturer-based financial service accounts, which may be financial service accounts that are associated with a manufacturer of products or services, such as a merchant.

Financial service provider 101 may include one or more financial service provider systems (FSP System) 101A. In one aspect, financial service provider system 101A may be one or more computing devices configured to perform one or more operations consistent with disclosed embodiments. In one aspect, financial service provider system 101A may be a desktop computer, a server, or any other type of computing device. Financial service provider system 101A may include one or more processors configured to execute software instructions stored in memory. The one or more processors may be configured to execute software instructions that when executed by a processor performs known Internet-related communication and financial service-based processes. For instance, financial service provider system 101A may execute software that provides data used for generating and displaying interfaces, including content on a display device included in, or connected to, mobile device 107. Financial service provider system 101A may also receive transaction authentication requests from mobile device 107, merchant device 105, and/or network 103, and may send these transaction requests to authorization system 101B for processing. Financial service provider system 101A may also send responses to the received transaction requests to mobile device 107, merchant device 105, and/or network 103. One such response sent to mobile device 107 may be a request for a pattern or a request to initiate an application (on mobile device 107) to collect a pattern. For example, FSP system 101A may receive a transaction request from merchant device 105 and determine that the transaction request is associated with a card including one or more patterns. FSP system 101A may then generate a communication including a request for the pattern and send the communication to mobile device 107.

Financial service provider 101 may include one or more authorization systems 101B. In one aspect, authorization system 101B may be one or more computing devices configured to perform one or more operations consistent with disclosed embodiments. For example, authorization system 101B may be a desktop computer, a server, or any other type of computing device. Authorization system 101B may include one or more processors configured to execute software instructions stored in memory. The one or more processors may be configured to execute software instructions that when executed by the one or more processors perform methods that enable the processing of financial transaction authorization requests. For instance, processing financial transaction authorization requests may involve communicating with one or more other systems to determine whether a pattern received with a transaction matches a pattern associated with a card.

Authorization system 101B may receive a communication from mobile device 107 that includes a pattern from item 200, and compare the pattern in the response to a stored pattern to determine whether or not the transaction is authorized.

The one or more processors may also be configured to enable the detection of potentially fraudulent transaction requests. For instance, authorization system 101B may receive a transaction request from financial service provider system 101A and may determine whether the received transaction request is potentially fraudulent, using transaction analysis procedures known in the art.

Network 103 may be any type of network configured to provide communications between components of system 100. For example, network 103 may be any type of network (including infrastructure) that provides communications, exchanges information, and/or facilitates the exchange of information, such as the Internet, a Local Area Network, Near-Field Communication (NFC), Bluetooth, or other suitable connection(s) that enables the sending and receiving of information between the components of system 100. In other embodiments, one or more components of system 100 may communicate directly through a dedicated communication link(s), such as links between financial service provider 101, merchant device 105, and/or mobile device 107.

Merchant device 105 may be operated by an entity that offers goods, services, and/or information, such as a big box retailer (e.g., a superstore/supercenter), a specialty store (e.g., a running store), a grocery store, an online retailer (e.g., operating a website to enable purchase of goods, services, or information), a service provider (e.g., a utility company), or any other type of entity that offers goods, services, and/or information that consumers (such as end-users or other business entities) may purchase, consume, use, etc. In some embodiments, merchant device 105 may comprise in-store devices such as a point-of-sale system (e.g., a cash register or self-checkout device), back-end devices (e.g., an online shopping cart system or payment gateway), or the like. In some embodiments, merchant device 105 may not be operated by a “merchant” but may be operated by another entity that enables data transmission, data decryption, funds transfer, software activation or acquisition, security services (e.g., hired by a management company to secure a building or a portion thereof), or the like.

Merchant device 105 may include one or more computing systems, such as server(s), desktop computers, etc., that are configured to execute stored software instructions to perform operations associated with a merchant, including one or more processes associated with processing purchase transaction requests, generating transaction request data, generating product data (e.g., SKU data) relating to transaction requests, etc. Merchant device 105 may perform one or more operations consistent with the disclosed embodiments. For example, merchant device 105 may receive information related to a product that a consumer wishes to purchase, for example, using wireless (e.g., barcode scanner, RFID, NFC, or the like) or wired (e.g., manual entry on a keyboard) systems. Merchant device 105 may perform a lookup in a database to determine the price of each product, and send (e.g., to FSP 101) a transaction request including information about the associated items. The disclosed embodiments are not limited to any particular configuration of merchant device 105.

Mobile device 107 may be one or more computing devices configured to perform one or more operations consistent with disclosed embodiments. in one example, mobile device 107 may be a tablet, a smart phone, a cellular phone, a personal digital assistant (PDA), a media device (such as an iPod®), or any other type of computing device. As mentioned herein, however, the disclosed embodiments are not limited to such examples. For example, in embodiments where a user is not likely to carry mobile device 107 or mobile device 107 is generally stationary, mobile device 107 may be implemented as a desktop, a laptop, or the like.

Mobile device 107 may include one or more processors configured to execute software instructions stored in memory, such as memory included in mobile device 107. Mobile device 107 may include software that when executed by a processor performs known Internet-related communication, content display processes, and financial service-related processes for a user of mobile device 107. For example, mobile device 107 may perform a lookup in a database to determine the price of each product, and send (e.g., to FSP 101) a transaction request including information about the associated items. As another example, mobile device 107 may execute browser or related mobile display software that generates and displays interfaces including content on a display device included in, or in communication with, mobile device 107. Mobile device 107 may execute applications and/or communication software that allows mobile device 107 to communicate with components over network 103, and generates and displays content in interfaces via a display device included in mobile device 107. The disclosed embodiments are not limited to any particular configuration of mobile device 107.

Mobile device 107 may be configured to communicate with network 103 using wired connections (e.g., Ethernet-based connections) or wireless connections (e.g., IEEE 802.11 wireless or “Wi-Fi” connections).

Mobile device 107 may also comprise at least one imaging device such as camera 107A. In some embodiments, camera 107A on mobile device 107 may be implemented using a sensor, such as a complementary metal-oxide semiconductor (CMOS), a semiconductor charge-coupled device (CCD), or an N-type metal-oxide-semiconductor device (NMOS). In some embodiments, camera 107A may be configured to detect invisible light (e.g., ultraviolet).

Mobile device 107 may comprise at least one touchscreen display 1078. Touchscreen display 1078 may be implemented using one or more of a resistive touchscreen panel, a surface acoustic wave (SAW) touchscreen panel, a capacitive touchscreen panel, or the like. Touchscreen display 1078 may enable interaction with a user (e.g., using a stylus or a user's finger). Touchscreen display 107B may also enable interaction with capacitive items printed or formed on top of other items. For example, touchscreen display 107B may detect capacitive ink printed on top of item 200 when item 200 is pressed onto touchscreen display 107B. Touchscreen display 107B may determine a pattern of capacitive ink printed on the card and generate data representing the pattern for sending to a CPU or other device in mobile device 107.

Item 200, in some embodiments, may be implemented as a variety of items, including a credit card, a debit card, a payment card, a loyalty card, a gift card, a token, or another item that relates to an account usable for transactions. Item 200, in some embodiments, may be a plastic card, but may also be implemented using other materials (e.g., composite, metal, wood, crystal, etc.). In embodiments where item 200 is a card, item 200 may be a card having a stripe storing information, a card having a contactless mechanism enabling information transfer, or a card having a contact mechanism enabling information transfer. In some embodiments, the card may be issued by FSP 100 and may be associated with an account maintained by FSP 100. Pattern item 200 may comprise pattern 221 which may be printed on top of pattern item 200. Pattern 221, in some embodiments, comprises invisible ink (e.g., visible only under certain types of light, such as ultraviolet (UV)), capacitive ink (e.g., that enable conducting of electricity), or the like.

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. For example, financial service provider system 101 and merchant device 105 may constitute a part of components of system 100 other than those specifically described, or may constitute a part of multiple components of system 100 (i.e., a distributed system).

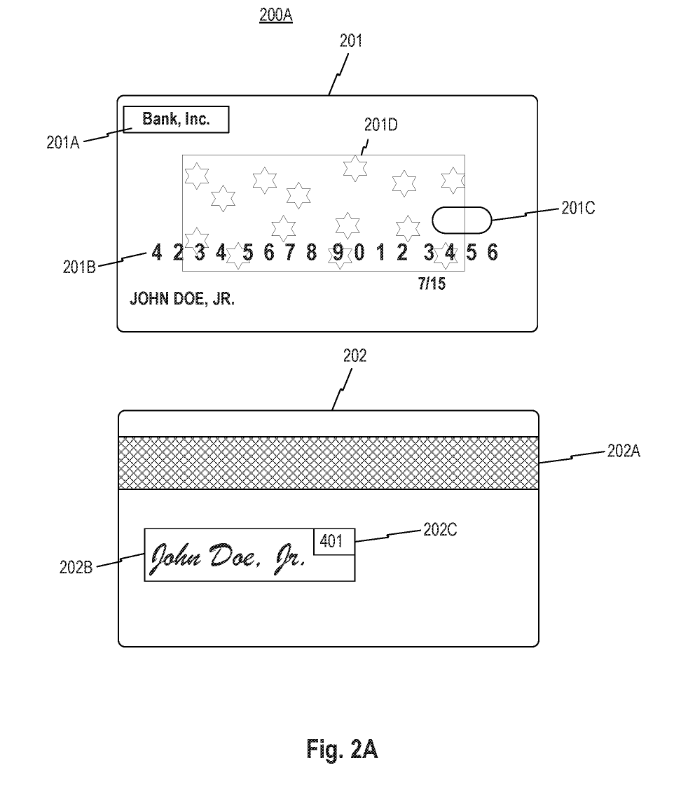

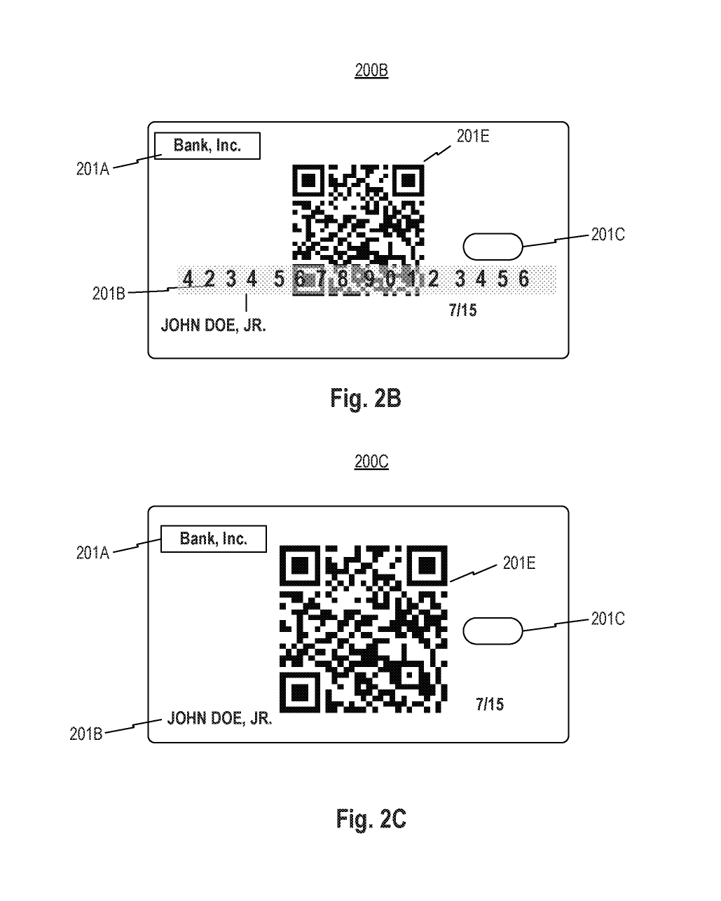

FIG. 2A is a diagram of an exemplary card 200A, consistent with disclosed embodiments. Obverse side 201 of card 200A comprises information (e.g., FSP identifier 201A, card data 201B, and card brand identifier 201C) and a printed pattern (201D).

FSP identifier 201A may comprise an identifier of a bank, credit union, credit card issuer, or the like, that provided card 200A to a cardholder. This may be a logo, a name, or a combination of both, and may be printed on card 200 or embossed on card 200. Card data 201B may comprise one or more of a card number, a cardholder name, a CVV number, an expiration date, etc. In some embodiments, card data 201B may be printed on card 200A, may be embossed (e.g., the characters of card data 201B being raised from the surface of card 200A), or may otherwise be represented on card 200. In some embodiments, information such as FSP identifier 201A, card data 201B, or card brand identifier 201C may be printed on reverse 202A or may not be printed on card 200A at all. Card brand identifier 201C may comprise an image (e.g., a logo) or text (e.g., “VISA,” “MASTERCARD,” etc.) that represents a network or card issuer associated with card 200A.

Pattern 201D may be implemented as one or more markings printed with capacitive ink. In some embodiments, these markings may be in the form of dots, stars, circles, or any other shape. The markings may be printed in a pattern that is known to at least one other device (e.g., merchant device 105). For example, a device such as FSP system 101A may generate a random or pseudo-random pattern and print capacitive ink on card 200A in that pattern (or cause such a pattern to be printed). In one aspect, pattern 201D may include more than one marking printed with capacitive ink. In another aspect, pattern 201D may be sized such that it is no larger than a typical touchscreen display. For example, pattern 201D may be sized such that it is no wider than substantially all touchscreen displays (e.g., two inches). In another aspect, each of the markings on pattern 201D may be oriented such that each marking is separate from each other marking. When using capacitive ink markings that are too close to one another, there is a chance that a touchscreen display could detect two markings as one large marking. So, as one way of avoiding this problem, each marking may be no less than 1 centimeter away from each other marking, as an example, so as to avoid a determination that two separate markings are only a single marking. In some embodiments, pattern 201D does not include one or more of FSP identifier 201A, card data 201B, or card brand identifier 201C.

Reverse 202 of card 200A contains magnetic stripe 202A, signature block 202B, and code 202C. Magnetic stripe 202A, in some embodiments, may contain data related to card 200 using one or more “tracks.” Each track on magnetic stripe 202A may be represented by a portion of magnetic stripe 202A and may contain different information. Magnetic stripe 202A may include information such as a card number, a name, or an expiration date (e.g., from card data 201B). Magnetic stripe 202A may also include a verification code (e.g., a CVV (Card Verification Value) or CVC (Card Verification Code)) which is intended to inform a payment processor, a payment network, a bank (e.g., FSP 101), or another party, that the card is “present” at the place where the transaction is taking place. In some embodiments, magnetic stripe 202A does not include a representation of pattern 201D (e.g., a numerical representation).

Not all embodiments of card 200A comprise magnetic stripe 202A. For example, information stored on magnetic stripe 202A (e.g., a card number, a name, an expiration date, a verification code, or the like) may instead be stored on a memory device, such as flash memory, (not pictured) inside of card 200A. Card 200A may also comprise a device (not pictured) that enables reading of this information from that memory device, such as a contactless device enabling information transmission via wireless communications (e.g., using Near Field Communication (“NFC”) Bluetooth, Bluetooth Low Energy (“BLE”), or in compliance with ISO/IEC 14443) or exposed electronics enabling information transmission using contact-based transmission (e.g., contact pads in compliance with ISO/IEC 7816).

Signature block 202B may contain a signature of the cardholder, which is intended for use by a merchant to determine whether a purchaser or customer using the card is an authorized cardholder (e.g., by determining whether the signature on a receipt/POS device matches the signature in signature block 202B). Code 202C may include a verification code (e.g., a CVV2 or CVC2) that, in some embodiments, is different from any verification code on magnetic stripe 202A (or stored in a memory device of card 200A) or pattern 201D.

FIG. 2B is a diagram of an exemplary card 200B, consistent with disclosed embodiments. As explained above with respect to FIG. 2A, obverse side 201B of card 200B comprises information (FSP identifier 201A, card data 201B, card brand identifier 201C) and a printed pattern (201E). FSP identifier 201A may comprise an identifier of a bank, credit union, credit card issuer, or the like, that provided card 200 to a cardholder. Card data 201B may comprise one or more of a card number, a cardholder name, or an expiration date. In some embodiments, card data 201B may be printed on card 200, may be embossed (e.g., the characters of card data 201B being raised from the surface of card 200), or may otherwise be represented on card 200. Card brand identifier 201C may comprise an image (e.g., a logo) or text (e.g., “VISA,” “MASTERCARD,” etc.) that represents a network or card issuer associated with card 200.

Pattern 201E may be implemented as a pattern printed with invisible or semi-invisible ink. In some embodiments, pattern 201E may be a barcode (1-dimensional or multi-dimensional), a shape, one or more characters, or another identifier, that is not normally viewable in standard light conditions. Pattern 201E may be printed in a manner such that a particular type of light source (e.g., ultraviolet, infrared, etc.) is required to view it. Pattern 201E may additionally be known to at least one other device (e.g., merchant device 105), is required to view it. In one aspect, a device such as FSP system 101A may generate a random or pseudo-random pattern and print capacitive ink on card 200B in that pattern (or cause such a pattern to be printed). In one aspect, pattern 201E includes more than one marking printed with invisible ink. In some embodiments, pattern 201E does not contain any of FSP identifier 201A, card data 201B, or card brand identifier 201C.

FIG. 2C is a diagram of an exemplary card 200C, consistent with disclosed embodiments. Card 200C contains many elements similar to those in card 200B, but may not have a printed card number on the obverse of the card (e.g., a PAN or Primary Account Number). This may be done because there is no number associated with the card or to maintain secrecy of such an associated number. In some embodiments, pattern 201 E may be larger on card 200C (i.e., larger than on card 200B) in order to ensure that pattern 201 E can be read reliably.

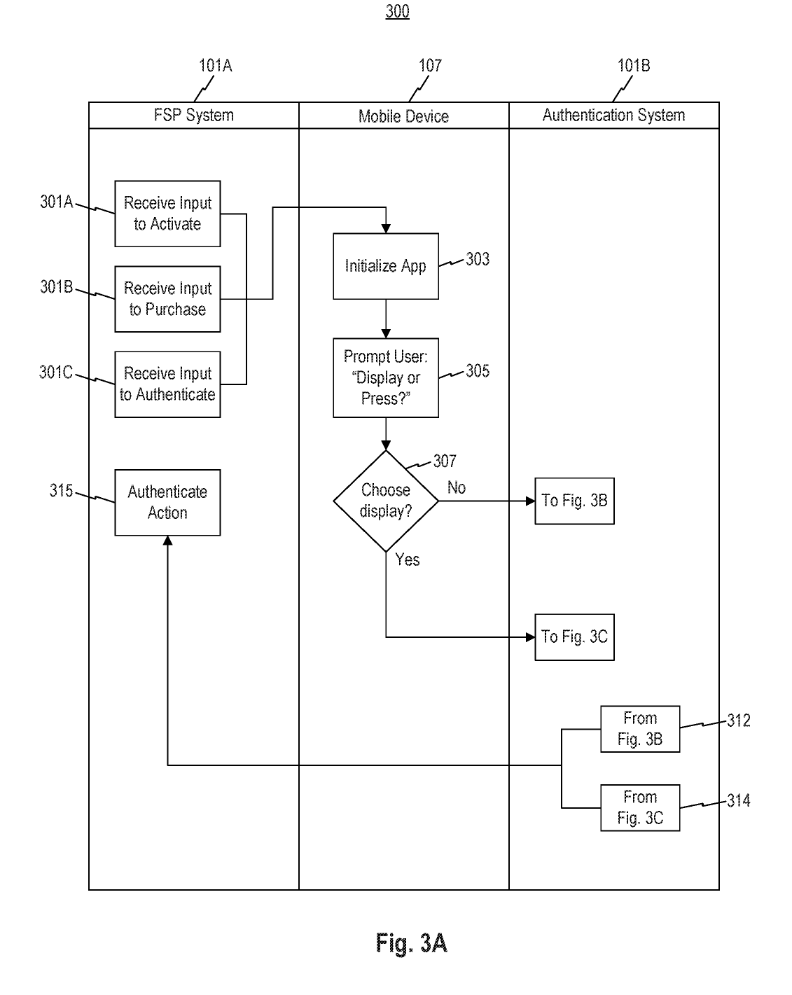

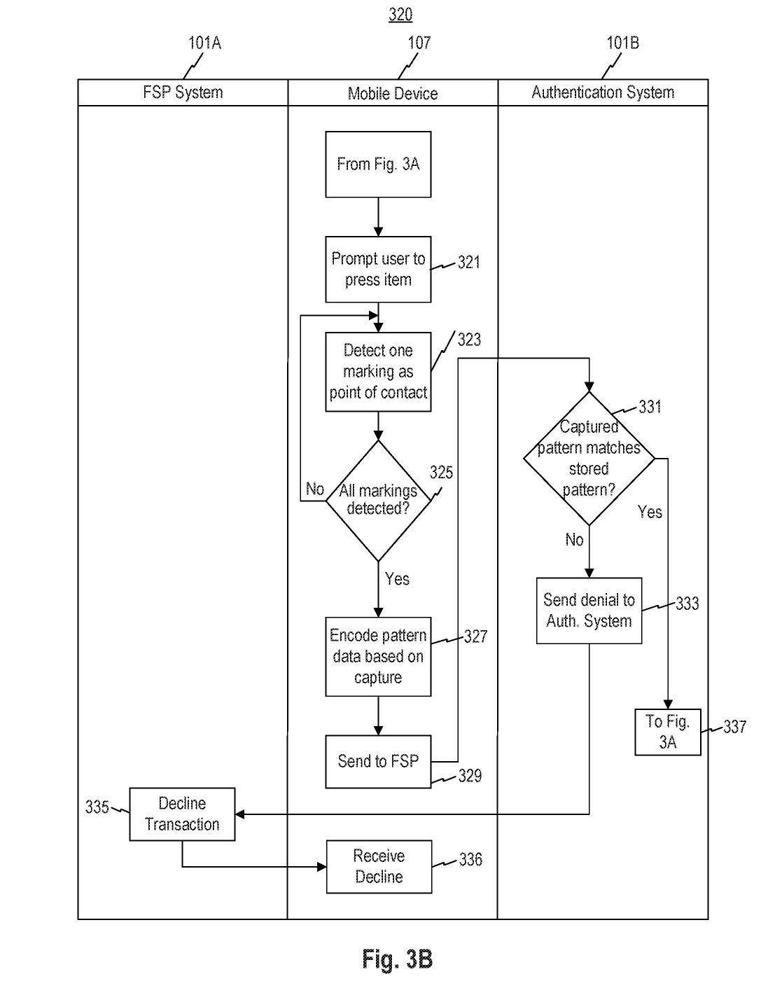

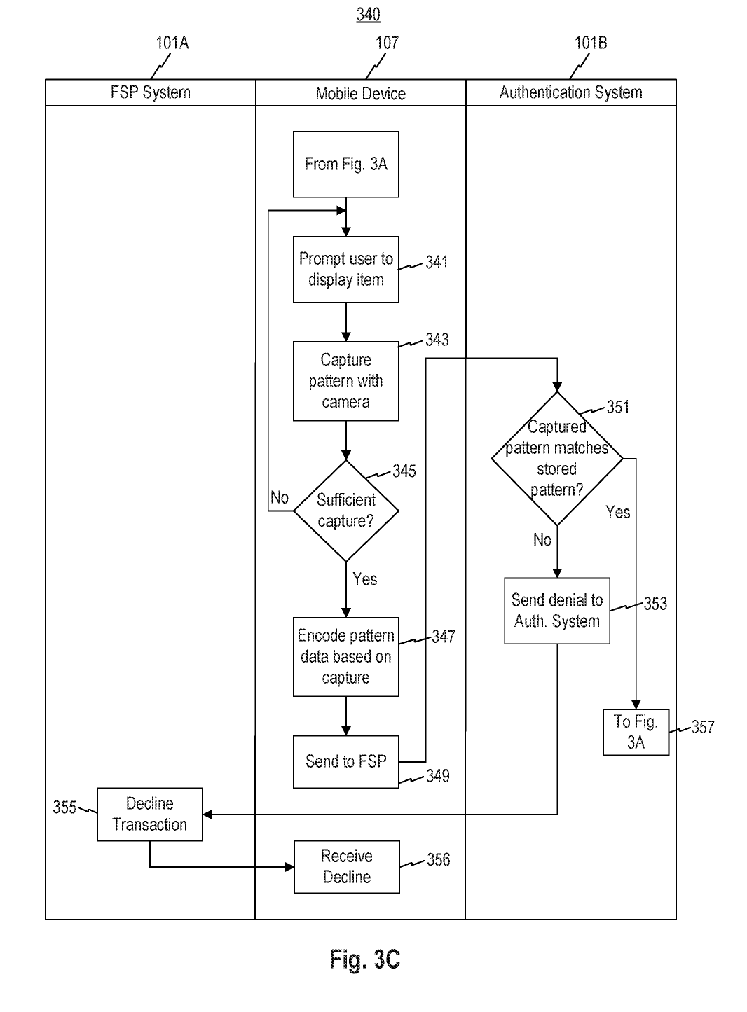

FIG. 3A is a flowchart of an exemplary process 300 for initiating a transaction using an authentication system and a mobile device, consistent with disclosed embodiments. Process 300 begins with at least one of three steps: steps 301A, 301B, or 301C.

In step 301A, FSP system 101A receives input that indicates a desire to activate an item (e.g., to enable the item for use). As one example, step 301A may trigger if a user attempts to activate a card or other item having a pattern on it. In step 301B, FSP system 101A receives input that indicates a desire to make a purchase. For example, step 301B may represent a user using a card or number associated with a card to pay for a purchase of goods or services. In step 301C, FSP system 101A receives input that indicates a desire to authenticate. As one example, step 301C may trigger if a user attempts to log in at a public terminal using a unique username and password. As further examples, step 301C may trigger if a user attempts to enter a restricted area of a building, decrypt a set of data, initiate a payment or other funds transfer, attempt to access a locked or encrypted portion of software, display hidden data in a program, initiate a data transfer between two devices, or the like. (In some embodiments, steps 301A, 301B, or 301C may be initiated at any of merchant device 105, mobile device 107, FSP system 101A, or authentication system 101B.)

After one of steps 301A, 301B, or 301C trigger, FSP system 101A may, in some embodiments, send a communication to mobile device 107 to cause mobile device 107 to initialize an application on mobile device 107 in order to continue the transaction, and process 300 may continue to step 303.

In step 303, mobile device 107 may initialize an application stored on mobile device 107. In some embodiments, mobile device 107 may initialize the application based on receiving a communication from FSP system 101A (e.g., a text message, in-app push notification, an email, or another communication). In other embodiments, mobile device 107 may initialize the application based on user input. For example, merchant device 105 may display a user interface that indicates that further verification is necessary, indicating that an application should be initialized.

In step 305, mobile device 107 may generate and display a user interface that requests input from a user. The input, in some embodiments, may request the user decide whether the user will authenticate by displaying an item (e.g., by taking a picture of the item) or by pressing an item against mobile device 107 (e.g., by pressing a portion having capacitive or other conductive material against mobile device 107). In step 307, if the user selects to press an item, process 300 continues to step 3B; if the user selects to display an item, process 300 continues to step 3C.

In either case, after continuing to step 3B or 3C, process 300 returns in one of steps 312 or 314. After returning, process 300 may continue to step 315, where FSP system 101A authenticates the action detected in at least one of steps 301A, 301B or 301C. FSP system 101A may, in some embodiments, send a communication to another device (e.g., merchant device 105 and/or mobile device 107) indicating that the transaction should proceed.

FIG. 3B is a flowchart of an exemplary process 320 for authenticating a transaction using touchscreen display 107B, consistent with disclosed embodiments. Process 320 begins at step 321. In step 321, mobile device 107 prompts a user (e.g., by generating and displaying a user interface) to press an item against mobile device 107. For example, mobile device 107 may prompt the user to press pattern 201D on card 200A against touchscreen display 107B of mobile device 107. Mobile device 107 may prompt the user to press pattern 201D against touchscreen display 107B by holding it against touchscreen display 107B for two seconds, may prompt the user to slide pattern 201D across touchscreen display 107B (e.g., from right-to-left), may prompt the user to hold pattern 201D against touchscreen display 107B by holding it against touchscreen display 107B until prompted to remove it (e.g., by presenting a message stating “Reading . . . Do Not Remove Card”), or the like.

In step 323, mobile device 107 may detect one point of contact from pattern 201D. For example, as explained above, pattern 201D may be implemented using one or more markings printed using capacitive ink. When such a marking is pressed against touchscreen display 107B, touchscreen display 107B may detect each marking as a point of contact, similar to detecting a finger or stylus press on touchscreen display 107B. Step 323 further represents detecting and recording (e.g., in memory) at least one of a location (e.g., an (x,y) location relative to the dimensions of touchscreen display 107B or mobile device 107), a size (e.g., in pixels or millimeters), or shape (e.g., the number of sides) of one of the markings on pattern 201D.

In step 325, mobile device 107 determines whether all markings on pattern 201D have been detected and/or recorded. If not, method 320 returns to step 323 to detect further points of contact. If mobile device 107 determines that all markings have been detected, process 320 continues to step 327. In step 327, mobile device 107 encodes the attributes of the detected markings as a proposed pattern. For example, mobile device 107 may compile a data structure comprising locations (e.g., (x, y) coordinates) of each marking detected. Mobile device may then send a communication including the data structure to authentication system 101B over a network such as network 103.

In step 331, authentication system 101B may receive the communication and extract the received data structure representing a captured pattern. Authentication system 101B may also compare the captured pattern to a stored pattern to determine whether there is a match. For example, authentication system 101B may request from a database (or other system) a pattern that is stored in association with card 200A. Step 331 may also represent authentication system 101B comparing the captured pattern with the stored pattern. For example, authentication system 101B may compare the locations of each marking in the stored pattern with the locations of each marking in the captured pattern (e.g., by calculating a Euclidean distance between each marking in the captured pattern and a corresponding marking in the stored pattern), and may deem the patterns to be a match if the distance is within some acceptable value (e.g., an average distance difference of less than 10 pixels for all markings). If authentication system 101B determines that the patterns match, the process continues to step 337 and back to FIG. 3A (where FSP system 101A may authenticate the action requested by the user). If, however, authentication system 101B determines that the patterns do not match, process 320 continues to step 333. In step 333, FSP device 101A may generate and send a message (e.g., to FSP system 101A) that indicates that the transaction should be declined. The message may include information such as why the transaction was declined (e.g., the patterns were not close enough of a match, the stored pattern included more/less points than the captured pattern, etc.). In step 335, FSP system 101A receives the message and forwards a communication to mobile device 107 indicating that the transaction was declined. In step 336, mobile device 107 may receive the communication indicating that the transaction was declined. Mobile device 107 may, in response, prompt the user to press obverse side 201 of card 200A against touchscreen display 107B again or may indicate that the user should retry the transaction.

FIG. 3C is a flowchart of an exemplary process 340 for authenticating a transaction using a camera on mobile device 107, consistent with disclosed embodiments. Process 340 begins at step 341. In step 341, mobile device 107 prompts a user (e.g., by generating and displaying a user interface) to display an item in front of mobile device 107. For example, mobile device 107 may prompt the user to hold card 200B no more than 6 inches away from the back of mobile device 107 such that mobile device 107 can capture a good quality picture of card 200B.

In step 343, mobile device 107 may capture a picture of pattern 201E on card 201. For example, as explained above, pattern 201E may be printed using one or more inks that are only visible under particular conditions (e.g., ultraviolet light). A camera on mobile device 107 may be configured to capture light that is not visible to human eyes. In some embodiments, mobile device 107 may capture an image of card 200B and apply one or more filters (e.g., software to modify a captured image) to extract ultraviolet light captured by the camera. Step 343 may also represent detecting and recording (e.g., in memory) at least one of a location (e.g., an (x, y) location relative to the dimensions of mobile device 107), a size (e.g., in pixels or millimeters), or shape (e.g., the number of sides) of markings of pattern 201E. In other embodiments, however, pattern 201E may be represented as a barcode or other symbolic representation.

In step 345, mobile device 107 determines whether the image captured by the camera on mobile device 107 is of sufficient quality. For example, mobile device 107 may determine whether pattern 201E is fully visible and discernable from the other portions of card 200B (e.g., FSP identifier 201A and card data 201B). If not, method 340 returns to step 341, where mobile device 107 may prompt the user to display card 200B again (e.g., in better lighting conditions, without blocking any part of the captured image with a finger, or the like). If mobile device 107 determines that the image is of sufficient quality, process 320 continues to step 347.

In step 347, mobile device 107 encodes the attributes of the detected pattern 201E as a proposed pattern. For example, mobile device 107 may compile a data structure comprising locations (e.g., (x, y) coordinates) of each detected pattern. As another example, pattern 201E may comprise a symbol, barcode, or other encoded information, and step 347 may represent compiling a data structure comprising a decoded representation of one or more symbols (e.g., the data represented by pattern 201E). Mobile device may then send a communication including the data structure to authentication system 101B over a network such as network 103.

In step 351, authentication system 101B may receive the communication and extract the received data structure representing a captured pattern. Authentication system 101B may also compare the captured pattern to a stored pattern to determine whether there is a match. For example, authentication system 101B may request from a database (or other system) a pattern that is stored in association with card 200B. Step 351 may also represent authentication system 101B comparing the captured pattern with the stored pattern. For example, authentication system 101B may compare the locations of each marking in the stored pattern with the locations of each marking in the captured pattern (e.g., by calculating a Euclidean distance between each marking in the captured pattern and a corresponding marking in the stored pattern), and may deem the patterns to be a match if the distance is within some acceptable value (e.g., an average distance difference of less than 10 pixels for all markings). In other embodiments, such as those where pattern 201E comprises a barcode, symbol, or other elements representing encoded information, authentication system 101B may deem the patterns to be a match if the encoded information in the captured pattern substantially matches (e.g., 90% the same or better) the information of the stored pattern.

If authentication system 101B determines that the patterns match, the process continues to step 357 and back to FIG. 3A (where FSP system 101A may authenticate the action requested by the user). If, however, authentication system 101B determines that the patterns do not match, process 340 continues to step 353. In step 353, authentication system 101B may generate and send a message (e.g., to authentication system 101B) that indicates that the transaction should be declined. The message may include information such as why the transaction was declined (e.g., the patterns were not close enough of a match or the stored pattern included more/less points than the captured pattern). In step 355, FSP system 101A receives the message and forwards a communication to mobile device 107 indicating that the transaction was declined. In step 356, mobile device 107 may receive the communication indicating that the transaction was declined. Mobile device 107 may, in response, prompt the user to display card 200B again or may indicate that the user should restart the transaction.

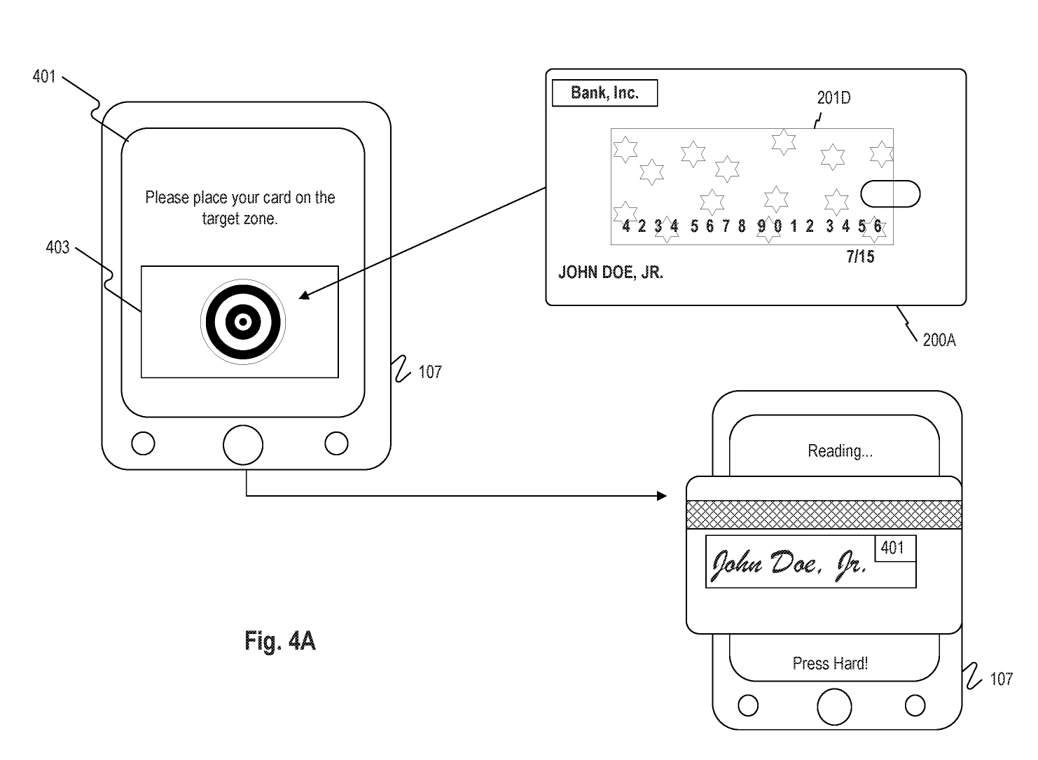

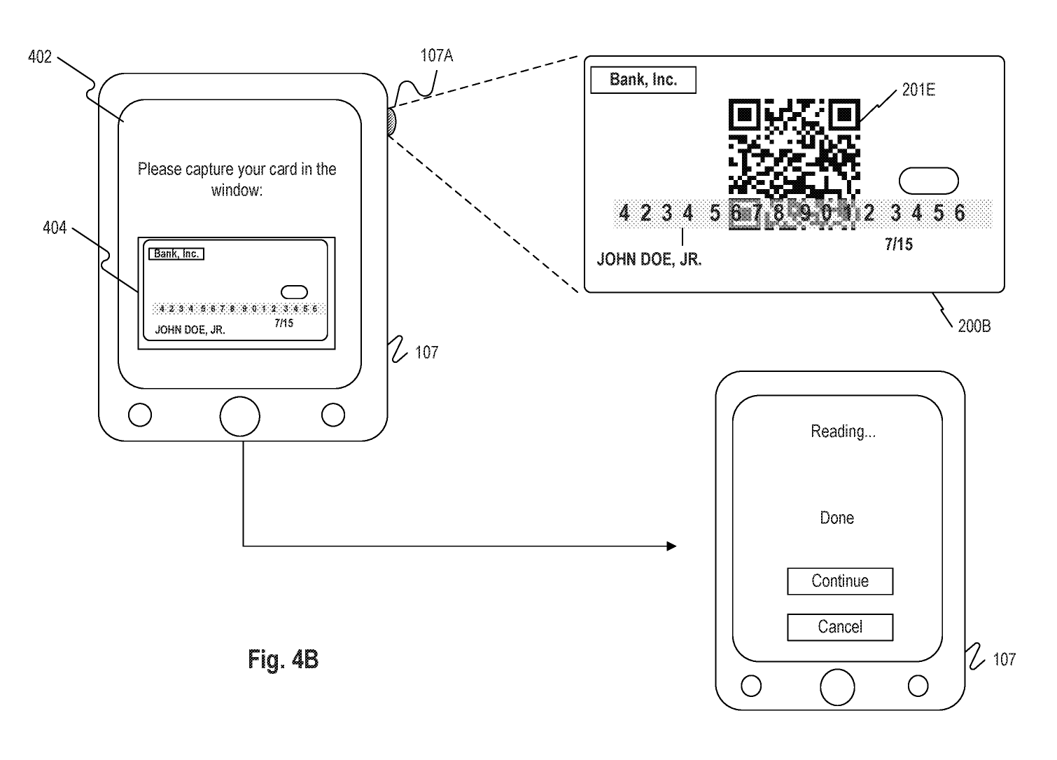

FIG. 4A is a diagram of an exemplary user interface 401 for a mobile device, enabling authentication of a transaction using an item having contact points, consistent with disclosed embodiments. Interface 401 may comprise a message eliciting a user to press an item (e.g., card 200A) on a target zone 403 on a touchscreen display 107B.

Responsive to the user pressing card 200A and pattern 201D on target zone 403, interface 401 may provide instructions to the user for ensuring that pattern 201D is fully read by touchscreen display 107B. For example, interface 401 may instruct the user to “Press Hard!” to ensure mobile device 107 can read each marking on pattern 201D or “Please Wait!” to allow mobile device 107 time to record each marking. Interface 401 may indicate to the user when mobile device 107 has fully read pattern 201D (e.g., by displaying text such as “Read Complete”).

FIG. 4B is a diagram of an exemplary user interface for a mobile device, enabling authentication of a transaction using an item having an ink pattern, consistent with disclosed embodiments. Interface 402 may comprise a message eliciting a user to display card 200B in view of camera 107A on mobile device 107. The user may position card 200B in view of camera 107A such that card 200B appears in view window 404. In some embodiments, pattern 201E will not be visible to the user in view window 404 because the user cannot view light in the ultraviolet spectrum. (In other embodiments, mobile device 107 may generate a false color for pattern 201E to enable a user to view it on view window 404.)

Responsive to the user displaying pattern 201E in view of camera 107A, interface 402 may provide instructions to the user for ensuring that pattern 201E is fully read by mobile device 107. For example, interface 402 may instruct the user to “Hold Card Closer” to allow mobile device 107 to get an accurate view of card 200B or to “Please Wait!” to allow mobile device 107 time to capture a clear image. Interface 402 may indicate to the user when mobile device 107 has fully read pattern 201E (e.g., by displaying text such as “Read Complete”).

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

1.-4. (canceled)

5. A method for authenticating a transaction using an item at a mobile device, comprising:
receiving an indication to start an application on a mobile device;
displaying a user interface, by the application, a request for a capture of a pattern on an item;
receiving, by the application, a pattern capture from the item;
determining whether the pattern capture is complete; and
sending the pattern capture to a first remote system for authenticating a transaction.

6. The method of claim 5, wherein receiving an indication comprises receiving the indication from a second remote system.

7. The method of claim 5, wherein:
the request for a capture of a pattern comprises a request for capture of capacitive markings on the item, and
receiving the pattern capture comprises determining one or more of a shape, location, or size of at least one capacitive marking by detecting each capacitive marking using a touchscreen display of the mobile device.

8. The method of claim 5, wherein:
the request for a capture of a pattern comprises a request for the capture of a pattern printed using invisible ink; and
receiving the pattern capture comprises using a camera to determine at least one of:
one or more of a shape, location, or size of one or more markings, or
information stored in an encoded format printed using invisible ink.

9. The method of claim 5, further comprising:
initiating the transaction on the mobile device; and
receiving the indication to start the application responsive to initiating the transaction.

10. A mobile device capable of authenticating a transaction using an item, comprising:
a processor,
at least one input device selected from the group of an imaging device and a touchscreen display; and
memory storing instructions configured to cause the processor to perform steps including:
receiving an indication to start an application;
displaying a user interface, by the application, a request for a capture of a pattern on an item;
receiving, by the application and the input device, a pattern capture from the item;
determining whether the pattern capture is complete; and
sending the pattern capture to a first remote system for authenticating a transaction.

11. The mobile device of claim 10, wherein receiving an indication comprises receiving the indication from a second remote system.

12. The mobile device of claim 10, wherein:
the request for a capture of a pattern comprises a request for capture of capacitive markings on the item, and
receiving the pattern capture comprises determining one or more of a shape, location, or size of at least one capacitive marking by detecting each capacitive marking using the touchscreen display of the mobile device.

13. The mobile device of claim 10, wherein:
the request for a capture of a pattern comprises a request for the capture of a pattern printed using invisible ink; and
receiving the pattern capture comprises using the imaging device to determine at least one of:
one or more of a shape, location, or size of one or more markings, or
information stored in an encoded format printed using invisible ink.

14. The mobile device of claim 10, further comprising:
initiating the transaction on the mobile device; and
receiving the indication to start the application responsive to initiating the transaction.

15. A non-transitory computer-readable medium comprising instructions configured to cause a processor of a mobile device to perform a method, the method comprising:
receiving an indication to start an application on a mobile device;
displaying a user interface, by the application, a request for a capture of a pattern on an item;
receiving, by the application, a pattern capture from the item;
determining whether the pattern capture is complete; and
sending the pattern capture to a first remote system for authenticating a transaction.

16. The computer-readable medium of claim 15, wherein receiving an indication comprises receiving the indication from a second remote system.

17. The computer-readable medium of claim 15, wherein:
the request for a capture of a pattern comprises a request for capture of capacitive markings on the item, and
receiving the pattern capture comprises determining one or more of a shape, location, or size of at least one capacitive marking by detecting each capacitive marking using a touchscreen display of the mobile device.

18. The computer-readable medium of claim 15, wherein:
the request for a capture of a pattern comprises a request for the capture of a pattern printed using invisible ink; and
receiving the pattern capture comprises using a camera to determine at least one of:
one or more of a shape, location, or size of one or more markings, or
information stored in an encoded format printed using invisible ink.

19. The computer-readable medium of claim 15, further comprising:
initiating the transaction on the mobile device; and
receiving the indication to start the application responsive to initiating the transaction.
